(19) United States
(12) Patent Application Publication
(10) Pub. No.: US 2024/0243357 A1
(43) Pub. Date: Jul. 18, 2024

(54) METHOD FOR PREPARING POLYMER SOLID ELECTROLYTE AND POLYMER SOLID ELECTROLYTE PREPARED THEREBY

(71) Applicant: LG ENERGY SOLUTION, LTD., Seoul (KR)

(72) Inventors: Jung Pil LEE, Daejeon (KR); Dong Kyu KIM, Daejeon (KR)

(21) Appl. No.: 18/561,279

(22) PCT Filed: Dec. 8, 2022
(86) PCT No.: PCT/KR2022/019897

§ 371 Date: Nov. 15, 2023

(30) Foreign Application Priority Data
Dec. 8, 2021 (KR) 10-2021-0175035
Dec. 7, 2022 (KR) 10-2022-0169918

(51) Int. Cl. H01M 10/0565; H01M 10/0525

(52) U.S. Cl. CPC H01M 10/0565; H01M 10/0525; H01M 2300/0082

(57) ABSTRACT

A method for preparing a polymer solid electrolyte, the polymer solid electrolyte prepared thereby, and an all-solid battery comprising the polymer solid electrolyte are provided. The method uses a polymer and a non-volatile liquid compound having poor miscibility with each other as raw materials, and a liquid-phase film and a polymer electrolyte film are formed by phase-separation that occurs when mixing and drying the raw materials, and the polymer solid electrolyte film exhibits the form of a uniform thin film.

### CROSS-REFERENCE TO RELATED APPLICATION(S)

This application is a National Stage Application of International Application No. PCT/KR2022/019897 filed on Dec. 8, 2022, which claims the benefit of priority based on Korean Patent Application No. 2021-0175035 filed on Dec. 8, 2021 and Korean Patent Application No. 2022-0169918 filed on Dec. 7, 2022, the disclosures of which are incorporated herein by reference in their entireties.

### FIELD OF DISCLOSURE

One aspect of the present disclosure relates to a method for preparing a polymer solid electrolyte and the polymer solid electrolyte prepared thereby.

### BACKGROUND

In terms of the capacity, safety, output, enlargement, microminiaturization, etc. of the batteries, various batteries that can overcome the limitations of current lithium secondary batteries are being studied.

Typically, continuous research is being conducted on a metal-air battery with a very large theoretical capacity in terms of capacity, an all-solid battery with no risk of explosion in terms of safety, a supercapacitor in terms of output, a NaS battery or redox flow battery (RFB) in terms of enlargement, a film thin battery in terms of microminiaturization, etc. compared to a current lithium secondary battery.

Among them, the all-solid battery means a battery in which the liquid electrolyte used in the existing lithium secondary battery is replaced by a solid material, and since the all-solid battery does not use a flammable solvent in the battery, there is no ignition or explosion caused by the decomposition reaction of the conventional electrolyte solution, so safety can be greatly improved. In addition, in the case of the all-solid battery, since Li metal or Li alloy can be used as a material for the negative electrode, there is an advantage that the energy density relative to the mass and volume of the battery can be remarkably improved.

As such, the all-solid battery is attracting attention as a next-generation lithium secondary battery, in terms of safety, high energy density, high output, and simplification of the manufacturing process.

However, since both the electrode and the solid electrolyte are solid and there is no liquid electrolyte in the all-solid battery, there is a problem that a dead space, that is, a void without ionic conductivity, occurs at the interface between the electrode and the solid electrolyte.

In addition, as a thickness of a battery is getting reduced, demand for a thin film solid electrolyte is increasing. However, there is a problem that, as the solid electrolyte becomes thin, its strength weakens, and thus it is not easy to separate from the release film attached to the solid electrolyte during the manufacturing process, and also the thin film is damaged while separating from the release film.

Therefore, there is a demand for the development of a technology capable of producing a solid electrolyte in the form of a uniform thin film.

### RELATED ART

Japanese Patent Publication No. 2020-526897

### SUMMARY

As a result of various studies to solve the above problems, the inventors of one aspect of the present disclosure confirmed that when a polymer and a non-volatile liquid compound having poor miscibility with each other are used as raw materials in preparation of a polymer solid electrolyte, a liquid-phase film and a polymer solid electrolyte film are formed by the phase-separation that occurs when mixing and drying the raw materials, and the polymer solid electrolyte film is obtained in the form of a uniform thin film.

Accordingly, it is an object of one aspect of the present disclosure to provide a method for preparing a polymer solid electrolyte in the form of a uniform thin film.

One aspect of the present disclosure relates to a method for preparing a polymer solid electrolyte, the method comprising: (S1) preparing a solution of a polymer, a non-volatile liquid-phase compound, a lithium salt, and a solvent; (S2) forming a coating layer by applying the solution on a substrate; (S3) drying the coating layer to form a liquid-phase film and a polymer solid electrolyte film; and (S4) separating the polymer solid electrolyte film and the liquid-phase film from the substrate.

The liquid-phase film may include the non-volatile liquid-phase compound, and the polymer solid electrolyte film comprises the polymer and the lithium salt, wherein the non-volatile liquid-phase compound is immiscible with the polymer, and wherein the liquid-phase film is formed on the substrate and the polymer solid electrolyte film is formed on the liquid-phase film.

A weight ratio of the polymer and the non-volatile liquid-phase compound in the solution may be 1:0.8 to 1:5.5.

The polymer may include one or more selected from the group consisting of polypropylene carbonate (PPC), polyacrylonitrile (PAN), and polyvinylpyrrolidone (PVP).

The non-volatile liquid-phase compound may include one or more selected from polyhedral oligomeric silsesquioxane (POSS) and ionic liquid.

POSS may include one or more functional groups (R), wherein the one or more functional groups (R) comprise one or more elements selected from O, N, S, Si and P, or are capable of binding to a lithium ion.

The one or more functional groups may be selected from the group consisting of poly (ethylene glycol) (PEG), alcohol, amine, carboxylic acid, allyl, epoxide, thiol, silane, and silanol

The ionic liquid may include a cation and an anion, and the cation comprises one or more selected from the group consisting of imidazolium, pyrazolium, triazolium, thiazolium, oxazolium, pyridazinium, pyrimidinium, pyrazinium, ammonium, phosphonium, pyridinium and pyrrolidinium, each of which are unsubstituted or substituted by an alkyl group having 1 to 15 carbon atoms.

The anion comprises one or more selected from the group consisting of PF₆⁻, BF₄⁻, CF₃SO₃⁻, N(CF₃SO₂)₂⁻, N(C₂F₅SO₂⁻)₂, C(CF₂SO₂)₃⁻, AsF₆⁻, SbF₆⁻, AlCl₄⁻, NbF₆⁻, HSO₄⁻, ClO₄⁻, CH₃SO₃⁻ and CF₃CO₂⁻.

The lithium salt may include one or more selected from the group consisting of LiTFSI (lithium bis (trifluoromethanesulphonyl)imide), LiFSI (Lithium bis(fluorosulfonyl)imide), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, and (FSO₂)₂NLi.

The substrate may include one or more selected from the group consisting of stainless steel (SS), a copper (Cu) foil, and an aluminum (Al) foil.

Forming the coating layer may be performed by bar coating, roll coating, spin coating, slit coating, die coating, blade coating, comma coating, slot die coating, lip coating, or solution casting.

A weight ratio of the polymer and the lithium salt may be 1:0.5 to 1:3.

The solvent may include one or more selected from the group consisting of propylene carbonate (PC), ethylene carbonate (EC), butylene carbonate (BC), diethyl carbonate (DEC), dimethyl carbonate (DMC), dipropyl carbonate (DPC), methyl propionate (MP), dimethyl sulfoxide, dimethoxyethane, diethoxyethane, tetrahydrofuran, N-methyl-2-pyrrolidone (NMP), ethylmethyl carbonate (EMC), vinylene carbonate (VC), gamma butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, ethyl propionate, and butyl propionate.

Drying the coating layer may be performed at 150° C. or less.

Another aspect of the present disclosure also provides a polymer solid electrolyte comprising the polymer and the lithium salt, prepared by the above described method.

A thickness of the polymer solid electrolyte may be 23 μm to 35 μm.

A thickness deviation of the polymer solid electrolyte may be 0.7 μm or less, and the thickness deviation is calculated from a deviation between a thickness at the thickest position and a thickness at the thinnest position among thicknesses measured at total of 9 designated positions in a sample punched out of the polymer solid electrolyte to a size of 3×3 cm².

The polymer solid electrolyte may be in the form of a free-standing film.

An ionic conductivity of the polymer solid electrolyte measured at 80° C. is from 1.2×10⁻⁵ to 4.5×10⁻⁵ S/cm.

Further another aspect of the present disclosure also provides an all-solid battery comprising the polymer solid electrolyte.

According to one aspect of the present disclosure, since a polymer and a non-volatile liquid-phase compound which are not miscible with each other are used as raw materials in the polymer solid electrolyte preparation process, a polymer solid electrolyte in the form of a uniform thin film can be prepared by forming and separating a laminate of a liquid-phase film and a polymer solid electrolyte film formed by the phase-separation that occurs while the polymer and the non-volatile liquid-phase compound are mixed and then dried.

In addition, in the polymer solid electrolyte preparation process, when forming the liquid-phase film and the polymer solid electrolyte film on the substrate, and then, separating the polymer solid electrolyte film from the substrate, the polymer solid electrolyte film can be separated without a resistance, due to the liquid-phase film adjacent to the substrate.

### BRIEF DESCRIPTION OF DRAWINGS

FIG. 1 is a schematic diagram showing a process for preparing a polymer solid electrolyte according to an embodiment of one aspect of the present disclosure.

FIG. 2 is a schematic diagram showing the structure of the laminate comprising the liquid-phase film and the polymer solid electrolyte film formed during the preparation process of the polymer solid electrolyte according to an embodiment of one aspect of the present disclosure.

FIG. 3 is a schematic diagram of a sample for measuring the uniformity of the polymer solid electrolyte prepared according to an example of one aspect of the present disclosure.

### DETAILED DESCRIPTION

Hereinafter, the present disclosure will be described in more detail to help the understanding of the present disclosure.

The terms and words used in the present specification and claims should not be construed as limited to ordinary or dictionary terms, and should be construed in a sense and concept consistent with the technical idea of the present disclosure, based on the principle that the inventor can properly define the concept of a term to describe his disclosure in the best way possible.

As used herein, the term “miscibility” refers to the property of being immiscible with each other.

As used herein, the term “free-standing film” refers to a film capable of maintaining the shape of a film by itself without a separate support at room temperature and atmospheric pressure.

### Preparation Method of Polymer Solid Electrolyte

One aspect of the present disclosure relates to a method for preparing a polymer solid electrolyte, the method comprising: (S1) preparing a solution of a polymer, a non-volatile liquid-phase compound, a lithium salt, and a solvent; (S2) forming a coating layer by applying the solution on a substrate; (S3) drying the coating layer to form a liquid-phase film and a polymer solid electrolyte film; and (S4) separating the polymer solid electrolyte film and the liquid phase film from the substrate; wherein the non-volatile liquid-phase compound is immiscible with the polymer, the liquid-phase film comprises the non-volatile liquid-phase compound and the polymer solid electrolyte film comprises the polymer and lithium salt.

In the manufacturing method of the polymer solid electrolyte, a polymer and a non-volatile liquid-phase compound having poor miscibility with each other are used as raw materials. In the case of the polymer and the non-volatile liquid-phase compound, a phenomenon of phase-separation occurs during drying after mixing them, and thus a liquid-phase film containing the non-volatile liquid-phase compound and a polymer solid electrolyte film containing a polymer may be formed, and accordingly, after the formation of a laminate formed by laminating the substrate, the liquid-phase film, and the polymer solid electrolyte film in the listed order, a polymer solid electrolyte can be obtained by separating the polymer solid electrolyte film. At this time, since the liquid-phase film is formed between the substrate and the polymer solid electrolyte film, the polymer solid electrolyte film can be easily separated from the substrate without resistance.

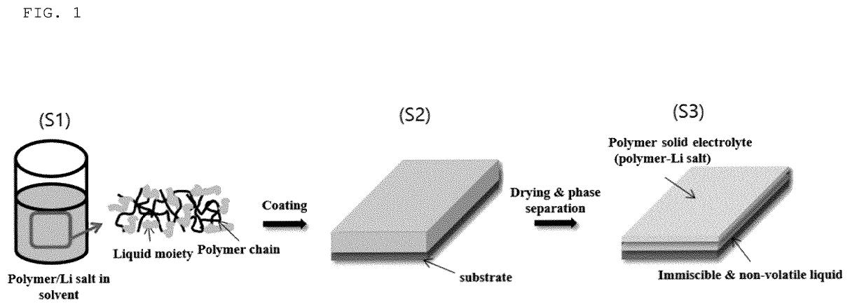

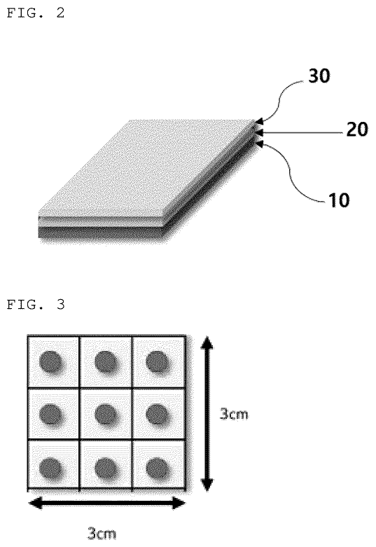

FIG. 1 is a schematic diagram showing a process for preparing a polymer solid electrolyte according to an example of one aspect of the present disclosure, and FIG. 2 is a schematic diagram showing the structure of the laminate comprising the liquid-phase film and the polymer solid electrolyte film formed during the preparation process of the polymer solid electrolyte according to an example of one aspect of the present disclosure.

With reference to these drawings, the preparation method of the polymer solid electrolyte according to one aspect of the present disclosure will be described in detail for each step.

In one aspect of the present disclosure, in step (S1), a polymer, a non-volatile liquid-phase compound, and lithium salt may be added to a solvent to prepare a solution for forming a polymer solid electrolyte.

The polymer may act to form a polymer solid electrolyte in the form of a uniform thin film, without reducing the electrical and ionic conductivity of the polymer solid electrolyte.

In addition, the polymer is not particularly limited as long as it is a polymer that exhibits immiscible property with respect to the non-volatile liquid-phase compound contained in the liquid-phase film, for example, the polymer may include one or more selected from the group consisting of polypropylene carbonate (PPC), polyacrylonitrile (PAN) and polyvinylpyrrolidone (PVP).

The non-volatile liquid-phase compound exhibits immiscible properties with respect to the polymer, and thus may be phase-separated from the polymer to form a liquid-phase film in the form of a separate layer, during the preparation process of the polymer solid electrolyte.

In addition, the non-volatile liquid-phase compound may comprise polyhedral oligomeric silsesquioxane (POSS) and/or ionic liquid.

POSS is a polyhedral oligosilsesquioxane, containing one or more functional groups (R), wherein the one or more functional groups (R) comprise one or more elements selected from O, N, S, Si and P, or are capable of binding to a lithium ion. For example, the one or more functional groups (R) may be one or more selected from poly(ethylene glycol) (PEG), alcohol, amine, carboxylic acid, allyl, epoxide, thiol, silane, silanol, silanol, glycidyl, octasilane, and methacryl.

In addition, POSS may be PEG-POSS including poly(ethylene glycol) (PEG) as afunctional group, and, when PEG-POSS is used, the phase-separation may be smoothly processed. For example, when PPC and PEG-POSS are used, the phase-separation may be smoothly processed and thus process efficiency may be enhanced.

In addition, POSS may be solid phase or liquid-phase according to the one or more functional groups (R). POSS of liquid-phase may be favorable for a smooth phase-separation from the polymer. POSS of liquid-phase may have the above said one or more functional groups (R), and preferably the liquid-phase POSS may be PEG-POSS.

In one aspect of the present disclosure, the liquid-phase POSS may be represented by the following chemical formula 1.

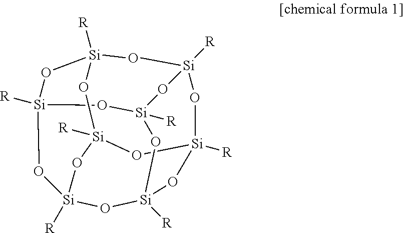

In chemical formula 1,
Each R is the same as or different from each other, and is selected from the following chemical formulas 1-1 to 1-4:

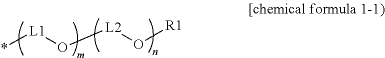

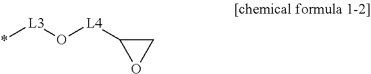

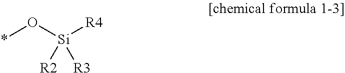

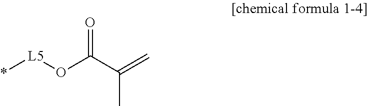

In chemical formulas 1-1 to 1-4,
L1 to L5 are C1 to C30 alkylene group,
R1 to R4 are selected from the group consisting of hydrogen; hydroxy group; amino group; thiol group; C1 to C30 alkyl group; C2 to C30 alkenyl group; C2 to C30 alkynyl group; C1 to C30 alkoxy group; and C1 to C30 carboxyl group, m and n are the same as or different from each other and are independently an integer of 0 to 10,
* is a bonding site.

In a specific embodiment of one aspect of the present disclosure, L1 to L5 are C1 to C30 alkylene group, R1 to R4 are selected from the group consisting of hydrogen; hydroxy group; and C1 to C30 alkyl group, and m and n are the same as or different from each other and are independently an integer of 0 to 1 in chemical formulas 1-1 to 1-4.

In a specific embodiment of one aspect of the present disclosure, the functional group R in chemical formula 1 is selected from the group consisting of poly(ethylene glycol) group, glycidyl group, octa silane group, and methacryl group.

In addition, the ionic liquid contains a cation and an anion, and the cation may comprise one or more selected from the group consisting of imidazolium, pyrazolium, triazolium, thiazolium, oxazolium, pyridazinium, pyrimidinium, pyrazinium, ammonium, phosphonium, pyridinium and pyrrolidinium, each of which are unsubstituted or substituted by an alkyl group having 1 to 15 carbon atoms, and the anion may comprise one or more selected from the group consisting of PF₆⁻, BF₄⁻, CF₃SO₃⁻, N(CF₃SO₂)₂⁻, N(C₂F₅SO₂)₂⁻, C(CF₂SO₂)₃⁻, AsF₆⁻, SbF₆⁻, AlCl₄⁻, NbF₆⁻, HSO₄⁻, ClO₄⁻, CH₃SO₃⁻, and CF₃CO₂⁻. For example, the ionic liquid may contain one or more selected from the group consisting of 1-ethyl-3-methyl imidazolium, 1-butyl-3-methyl imidazolium, 1-butyl-1-methyl pyrrolidinium, 1-methyl-1-proply piperidinium, bis(trifluoromethylsulfonyl)imide (TFSI), and trifluoromethanesulfonate.

The lithium salt can impart ionic conductivity to the polymer solid electrolyte, and can improve ionic conductivity without reducing the electrical conductivity by the electrical conductivity polymer.

In addition, the lithium salt may comprise one or more selected from the group consisting of LiTFSI (lithium bis(trifluoromethanesulphonyl)imide), LiFSI (Lithium bis(fluorosulfonyl)imide), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, (FSO₂)₂NLi, chloroborane lithium, lower aliphatic carboxylic acid lithium, and 4-phenylboric acid lithium.

The weight ratio of the polymer and the non-volatile liquid-phase compound may be 1:0.8 to 1:5.5, specifically, 1:0.8 or less, 1:0.9 or less, or 1:1 or less, and 1:5 or more, 1:5.2 or more, or 1:5.5 or more. If the weight ratio exceeds 1:0.8, the content of the polymer is excessively increased, so that a phenomenon of phase-separation does not occur, a polymer solid electrolyte in the form of a free-standing film is prepared in a state where the polymer and the non-volatile liquid-phase compound are simply mixed, and the uniformity and ionic conductivity of the polymer solid electrolyte may be reduced. In addition, if the weight ratio is less than 1:5.5, the content of the non-volatile liquid-phase compound is excessively increased, so that a solid polymer electrolyte is not prepared, and an electrolyte of the liquid-phase may be prepared.

In addition, the weight ratio of the polymer and the lithium salt may be 1:0.5 to 1:3, specifically, 1:0.5 or less, 1:0.6 or less, or 1:0.7 or less, and 1:1.5 or more, 1:2 or more, or 1:3 or more. If the weight ratio exceeds 1:0.5, the content of the polymer may be excessively increased, so that the ionic conductivity of the polymer solid electrolyte may be reduced. If the weight ratio is less than 1:3, the content of the lithium salt may be excessively increased, so that the polymer electrolyte film may not be formed.

The solvent is not particularly limited as long as it is a solvent used in the preparation of an electrolyte in the art. For example, the solvent may comprise one or more selected from the group consisting of propylene carbonate (PC), ethylene carbonate (EC), butylene carbonate (BC), diethyl carbonate (DEC), dimethyl carbonate (DMC), dipropyl carbonate (DPC), methyl propionate (MP), dimethyl sulfoxide, dimethoxyethane, diethoxyethane, tetrahydrofuran, N-methyl-2-pyrrolidone (NMP), ethylmethyl carbonate (EMC), vinylene carbonate (VC), gamma butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, ethyl propionate, and butyl propionate.

The concentration of the solution for forming the polymer solid electrolyte is not particularly limited as long as the concentration is sufficient to perform the coating process. For example, the concentration of the solution for forming the polymer solid electrolyte may be 10 to 40% by weight, specifically 10% by weight or more, 15% by weight or more or 20% by weight or more, and 30% by weight or less, 35% by weight or less or 40% by weight or less. The concentration may be appropriately adjusted to a concentration sufficient to perform the coating process within the above range.

In addition, the solution for forming the polymer solid electrolyte is in the form of a mixture of a liquid moiety and a polymer chain.

The liquid moiety is derived from the non-volatile liquid-phase compound, and the polymer chain is derived from the polymer. Since the non-volatile liquid-phase compound and the polymer are immiscible with each other, the non-volatile liquid-phase compound and the polymer are present in a solution while being separated from each other.

In the one aspect of the present disclosure, in step (S2), the solution for forming the polymer solid electrolyte may be applied on a substrate to form a coating layer.

The substrate may be in the form of a foil, and the foil may be in the form of a thin film of a metal such as aluminum, copper, or stainless steel. By using the foil in the form of a metal thin film as the substrate, it may be advantageous for the preparation of a solid electrolyte in the form of a free-standing film.

In addition, the coating method may be bar coating, roll coating, spin coating, slit coating, die coating, blade coating, comma coating, slot die coating, lip coating, or solution casting, but is not limited thereto as long as it is capable of forming a coating layer on the substrate.

In one aspect of the present disclosure, in step (S3), the coating layer is dried, and the coating layer is phase-separated into a liquid-phase film and a polymer electrolyte film.

The drying is not particularly limited as long as it is a drying method that can induce phase-separation of the liquid moiety and the polymer chain contained in the coating layer. For example, the drying may be performed at 150° C. or less, 130° C. or less, or 110° C. or less.

The phase-separation may occur due to the characteristic that the polymer and the non-volatile liquid-phase compound, which are raw materials, are immiscible with each other.

As shown in FIG. 2, the liquid-phase film 20 comprising the non-volatile liquid-phase compound may be formed on the substrate 10, and the polymer solid electrolyte film 30 comprising the polymer and lithium salt may be formed on the liquid-phase film 20.

In one aspect of the present disclosure, in step (S4), the polymer solid electrolyte film may be separated from the substrate.

In general, as the polymer solid electrolyte film is thinned, the strength is weakened, and thus it may be difficult to separate from the substrate. However, since the liquid-phase film is formed between the substrate and the polymer solid electrolyte film in step (S3), the polymer solid electrolyte film can be separated from the substrate without a resistance.

Moreover, after separating the polymer solid electrolyte film, a washing step may be performed to remove remaining non-volatile liquid-phase compound on the polymer solid electrolyte film.

### Polymer Solid Electrolyte

Another aspect of the present disclosure also provides a polymer solid electrolyte prepared by the method for preparing a polymer solid electrolyte as described above.

The polymer solid electrolyte includes a polymer and a lithium salt. The type and weight ratio of the polymer and the lithium salt are the same as described above.

In another aspect of the present disclosure, the thickness of the polymer solid electrolyte may be 23 μm to 35 μm, and may be reduced compared to the general polymer solid electrolyte, thereby representing the form of a thin-film solid electrolyte. If the thickness is less than 23 μm, the durability of the polymer solid electrolyte may be lowered. If the thickness exceeds 35 μm, it may act as a resistance during operation of the battery.

In addition, the thickness deviation of the polymer solid electrolyte may be 0.7 μm or less. Within the above range, the smaller the thickness deviation is, the better uniformity is achieved. If the thickness deviation exceeds 0.7 μm, the uniformity of the polymer solid electrolyte is not good. For example, in the case of the thickness deviation, for the sample punched out of the polymer solid electrolyte to a size of 3×3 cm², the thickness was measured at a total of 9 designated positions, and then the deviation between the thickness at the thickest position and the thickness at the thinnest position was calculated. It was judged that the smaller the deviation of the calculated thickness is, the more uniform thickness is achieved.

In another aspect of the present disclosure, the polymer solid electrolyte may be in the form of a free-standing film.

The polymer solid electrolyte in the form of a free-standing film maintains the form of a film by itself at room temperature and atmospheric pressure, and thus can be applied to various applications.

In another aspect of the present disclosure, the ionic conductivity of the polymer solid electrolyte measured at 80° C. may be from 1.2×10⁻⁵ to 4.5×10⁻⁵ S/cm. When the polymer solid electrolyte with the ionic conductivity in the above said range is applied to an all-solid battery, stability of the battery is enhanced and performance and life span of the battery are improved.

### All-Solid Battery

Yet another aspect of the present disclosure also relates to an all-solid battery comprising the polymer solid electrolyte described above, wherein the all-solid battery may comprise a positive electrode, a negative electrode, and the polymer solid electrolyte disposed therebetween.

In addition, the polymer solid electrolyte may be applied to the electrode, and thus may be comprised in an all-solid battery in a state of being attached to one surface of the positive electrode or the negative electrode.

In further another aspect of the present disclosure, the positive electrode comprises a positive electrode current collector and a positive electrode active material layer formed on the positive electrode current collector.

The positive electrode active material layer comprises a positive electrode active material, a binder, and an electrically conductive material.

The positive electrode active material is not particularly limited as long as it is a material capable of reversibly intercalating and de-intercalating lithium ions, for example, may be, but is not limited to, layered compounds or compounds substituted with one or more transition metals, such as lithium cobalt oxide (LiCoO₂), lithium nickel oxide (LiNiO₂), Li[NiₓCo_{y}Mn_{z}Mᵥ]O₂ (wherein, M is any one or two or more elements selected from the group consisting of Al, Ga and In; 0.3≤x<1.0, 0≤y, z≤0.5, 0≤v≤0.1, x+y+z+v=1), Li(LiₐM_{b-a-b′}M′_{b′})O_{2-c}Ac (wherein, 0≤a≤0.2, 0.6≤b≤1, 0≤b′≤0.2, 0≤c≤0.2; M comprises Mn and one or more selected from the group consisting of Ni, Co, Fe, Cr, V, Cu, Zn and Ti; M′ is one or more selected from the group consisting of Al, Mg and B, and A is one or more selected from the group consisting of P, F, S and N); lithium manganese oxide such as Formula Li_{1+y}Mn_{2-y}O₄ (wherein, y is 0-0.33), LiMnO₃, LiMn₂O₃ and LiMnO₂; lithium copper oxide (Li₂CuO₂); vanadium oxide such as LiV₃O₈, LiFe₃O₄, V₂O₅ and Cu₂V₂O₇; Ni site type lithium nickel oxide represented by Formula LiNi_{1-y}MyO₂ (wherein, M=Co, Mn, Al, Cu, Fe, Mg, B or Ga, y=0.01-0.3); lithium manganese composite oxide represented by Formula LiMn_{2-y}M_{y}O₂ (wherein, M=Co, Ni, Fe, Cr, Zn or Ta, y=0.01-0.1) or Li₂Mn₃MO₈ (wherein, M=Fe, Co, Ni, Cu or Zn); disulfide compounds; Fe₂(MoO₄)₃.

The positive electrode active material may be contained in an amount of 40 to 80% by weight based on the total weight of the positive electrode active material layer. Specifically, the content of the positive electrode active material may be 40% by weight or more or 50% by weight or more, and may be 70% by weight or less or 80% by weight or less. If the content of the positive electrode active material is less than 40% by weight, the connectivity between the wet positive electrode active material layer and the dry positive electrode active material layer may be insufficient. If the content of the positive electrode active material exceeds 80% by weight, mass transfer resistance may be increased.

In addition, the binder is a component that assists bonding between the positive electrode active material and the electrically conductive material, and assists in bonding to the current collector. The binder may comprise one or more selected from the group consisting of styrene butadiene rubber, acrylated styrene butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethyl cellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride, and poly(vinylidene fluoride)-hexafluoropropene. Preferably, the binder may comprise one or more selected from the group consisting of styrene-butadiene rubber, polytetrafluoroethylene, carboxymethyl cellulose, polyacrylic acid, lithium polyacrylate, and polyvinylidene fluoride.

In addition, the binder may be contained in an amount of 1% by weight to 30% by weight based on the total weight of the positive electrode active material layer, and, specifically, the content of the binder may be 1% by weight or more or 3% by weight or more, and may be 15% by weight or less or 30% by weight or less. If the content of the binder is less than 1% by weight, the adhesive force between the positive electrode active material and the positive electrode may be lowered. If the content of the binder exceeds 30% by weight, the adhesive force is improved, but the content of the positive electrode active material is reduced by that amount, and thus the capacity of the battery may be lowered.

In addition, the electrically conductive material is not particularly limited as long as it has excellent electrical conductivity without causing side reactions in the internal environment of the all-solid battery and without causing chemical changes in the battery. The electrically conductive material may be typically graphite or conductive carbon, for example, as the electrically conductive material, graphite such as natural graphite, artificial graphite; carbon black such as carbon black, acetylene black, Ketjen black, Denka black, thermal black, channel black, furnace black, lamp black, thermal black; carbon-based materials whose crystal structure is graphene or graphite; electrically conductive fibers such as carbon fibers and metal fibers; carbon fluoride; metal powders such as aluminum powder and nickel powder; electrically conductive whiskers such as zinc oxide and potassium titanate; electrically conductive oxides such as titanium oxide; and electrically conductive polymers such as polyphenylene derivatives may be used alone or in combination of two or more thereof, but is not necessarily limited thereto.

The electrically conductive material may be generally contained in an amount of 0.5% by weight to 30% by weight based on the total weight of the positive electrode active material layer, and specifically, the content of the electrically conductive material may be 0.5% by weight or more or 1% by weight or more, and may be 20% by weight or less or 30% by weight or less. If the content of the electrically conductive material is too small, i.e., less than 0.5% by weight, it is difficult to expect an effect of improving electrical conductivity or the electrochemical properties of the battery may be deteriorated. If the content of the electrically conductive material exceeds 30% by weight and thus is too large, the amount of the positive electrode active material may be relatively small, so that the capacity and energy density may be lowered. A method for incorporating the electrically conductive material to the positive electrode is not particularly limited, and a conventional method known in the art, such as coating on the positive electrode active material, may be used.

In addition, the positive electrode current collector supports the positive electrode active material layer, and serves to transfer electrons between the external conductive wire and the positive electrode active material layer.

The positive electrode current collector is not particularly limited as long as it has high electrical conductivity without causing chemical changes in the all-solid battery. For example, as the positive electrode current collector, copper, stainless steel, aluminum, nickel, titanium, palladium, sintered carbon; a copper or stainless steel surface-treated with carbon, nickel, silver, etc.; an aluminum-cadmium alloy, etc. may be used.

The positive electrode current collector may have a fine irregularity structure on the surface of the positive electrode current collector or have a three-dimensional porous structure, in order to strengthen the bonding force with the positive electrode active material layer. Accordingly, the positive electrode current collector may comprise various forms such as a film, a sheet, a foil, a mesh, a net, a porous body, a foam, and a non-woven fabric.

The positive electrode as described above may be prepared by the conventional method, and specifically, the positive electrode is manufactured by coating and drying a composition for forming the positive electrode active material layer prepared by mixing the positive electrode active material, the electrically conductive material and the binder in an solvent, onto the positive electrode current collector, and optionally compression-molding it onto the positive electrode current collector to improve the positive electrode density. At this time, as the solvent, it is preferable to use one that can uniformly disperse the positive electrode active material, the binder, and the electrically conductive material and that evaporates easily. Specifically, acetonitrile, methanol, ethanol, tetrahydrofuran, water, isopropyl alcohol and the like are exemplified.

In the other aspect of the present disclosure, the negative electrode comprises a negative electrode current collector and a negative electrode active material layer formed on negative electrode current collector. The negative electrode active material layer comprises a negative electrode active material, a binder, and an electrically conductive material.

The negative electrode active material may be a material capable of reversibly intercalating or de-intercalating lithium ion (Li⁺), a material capable of reacting with lithium ion to reversibly form a lithium-containing compound, lithium metal, or a lithium alloy.

The material capable of reversibly intercalating or de-intercalating lithium ion (Li⁺) may be, for example, crystalline carbon, amorphous carbon, or mixtures thereof. The material capable of reacting with lithium ion (Li⁺) to reversibly form a lithium-containing compound may be, for example, tin oxide, titanium nitrate, or silicon. The lithium alloy may be, for example, an alloy of lithium (Li) and the metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), and tin (Sn).

Preferably, the negative electrode active material may be lithium metal, and specifically, may be in the form of a lithium metal thin film or lithium metal powder.

The negative electrode active material may be contained in an amount of 40 to 80% by weight based on the total weight of the negative electrode active material layer. Specifically, the content of the negative electrode active material may be 40% by weight or more or 50% by weight or more, and may be 70% by weight or less or 80% by weight or less. If the content of the negative electrode active material is less than 40% by weight, the connectivity between the wet negative electrode active material layer and the dry negative electrode active material layer may be insufficient. If the content of the negative electrode active material exceeds 80% by weight, mass transfer resistance may be increased.

In addition, the binder is the same as described above for the positive electrode active material layer.

In addition, the electrically conductive material is the same as described above for the positive electrode active material layer.

In addition, the negative electrode current collector is not particularly limited as long as it has electrical conductivity without causing chemical change in the battery, for example, may be copper, stainless steel, aluminum, nickel, titanium, sintered carbon; copper or stainless steel surface-treated with carbon, nickel, titanium, silver, etc.; or aluminum-cadmium alloy. In addition, the negative electrode current collector may be used in various forms, such as a film having a fine irregularity structure on its surface, a sheet, a foil, a net, a porous body, a foam, and a non-woven fabric, as in the positive electrode current collector.

The manufacturing method of the negative electrode is not particularly limited, and may be manufactured by forming a negative electrode active material layer on a negative electrode current collector using a layer or film formation method commonly used in the art. For example, a method such as pressing, coating, or vapor deposition may be used. Also, a case where a thin film of a metal lithium is formed on a metal plate by initial charging after assembling the battery without a lithium thin film on the negative electrode current collector is also included in the negative electrode of the present disclosure.

The manufacture of the all-solid battery having the above configuration is not particularly limited in the present disclosure, and a known method may be used.

When manufacturing the all-solid battery of the present disclosure, electrodes comprising the positive electrode and the negative electrode are arranged, and then press-molded to assemble a cell.

The assembled cell is installed in the exterior material, and then sealed by heat compression or the like. As the exterior material, a laminate pack made of aluminum or stainless steel, and a cylindrical or rectangular metal container are very suitable.

Hereinafter, preferred examples of the present disclosure will be described in order to facilitate understanding of the present disclosure. It will be apparent to those skilled in the art, however, that the following examples are only illustrative of the present disclosure and various changes and modifications can be made within the scope and spirit of the present disclosure, and that such variations and modifications are within the scope of the appended claims.

In the following Examples and Comparative Examples, solid electrolytes were prepared according to the type and weight ratio of the substrate, the polymer, the lithium salt, and the solvent as shown in Table 1 below.

TABLE 1

| | Polymer solid electrolyte | | | | | |
|---|---|---|---|---|---|---|
| | | | Non-volatile | Weight | | |
| | | | liquid-phase | ratio | Lithium | |
| | Substrate | Polymer | compound | (PPC:POSS) | salt | Solvent |
| Example 1 | SS Foil | PPC | PEG-POSS | 1:1 | LiTFSI | NMP |
| Example 2 | SS Foil | PPC | PEG-POSS | 1:2 | LiTFSI | NMP |
| Example 3 | SS Foil | PPC | PEG-POSS | 1:5 | LiTFSI | NMP |
| Comparative | SS Foil | PPC | — | — | LiTFSI | NMP |
| Example 1 | | | | | | |
| Comparative | PET | PPC | — | — | LiTFSI | NMP |
| Example 2 | release | | | | | |
| | film | | | | | |
| Comparative | SS Foil | PPC | PEG-POSS | 1:6 | LiTFSI | NMP |
| Example 3 | | | | | | |
| Comparative | SS Foil | PPC | PEG-POSS | 1:0.5 | LiTFSI | NMP |
| Example 4 | | | | | | |

### Example 1

As raw materials for preparing a polymer solid electrolyte, polypropylene carbonate (PPC) which is the polymer, poly(ethyleneglycol)-polyhedral oligomeric silsesquioxane (PEG-POSS) which is the non-volatile liquid-phase compound, LiTFSI which is the lithium salt, and NMP which is the solvent were prepared. The weight ratio of polypropylene carbonate (PPC), poly(ethyleneglycol)-polyhedral oligomeric silsesquioxane (PEG-POSS), and LiTFSI was set to 1:1:1.

The polymer, the non-volatile liquid-phase compound, and the lithium salt were added to the solvent and mixed to prepare a solution at a concentration of 20%.

The solution was bar-coated on a stainless steel (SS) Foil, which is the substrate, to form a coating layer.

Thereafter, the coating layer was vacuum-dried at 100° C. During drying, phase-separation was occurred, such that a laminate, in which a liquid-phase film comprising the non-volatile liquid-phase compound and a polymer solid electrolyte film comprising the polymer and lithium salt on the SS Foil are sequentially laminated, was manufactured. By separating the SS Foil from the laminate, a polymer solid electrolyte comprising a liquid-phase film and a polymer solid electrolyte film formed on the liquid-phase film was obtained.

### Example 2

A polymer solid electrolyte was prepared in the same manner as in Example 1, except that the weight ratio of PPC and PEG-POSS used as the polymer and the non-volatile liquid-phase compound was set to 1:2.

### Example 3

A polymer solid electrolyte was prepared in the same manner as in Example 1, except that the weight ratio of PPC and PEG-POSS used as the polymer and the non-volatile liquid-phase compound was set to 1:5.

### Comparative Example 1

A polymer solid electrolyte was prepared in the same manner as in Example 1, except that the non-volatile liquid-phase compound was not used.

### Comparative Example 2

A polymer solid electrolyte was prepared in the same manner as in Example 1, except that the non-volatile liquid-phase compound was not used, and a PET (polyethylene terephthalate) release film was used instead of the SS Foil as a substrate.

### Comparative Example 3

A polymer solid electrolyte was prepared in the same manner as in Example 1, except that the weight ratio of PPC and PEG-POSS used as the polymer and the non-volatile liquid-phase compound was set to 1:6.

### Comparative Example 4

A polymer solid electrolyte was prepared in the same manner as in Example 1, except that the weight ratio of PPC and PEG-POSS used as the polymer and the non-volatile liquid-phase compound was set to 1:0.5.

### Experimental Example 1: Evaluation of Polymer Solid Electrolyte

For the polymer solid electrolytes prepared in Examples and Comparative Examples, possibility of the form of a free-standing film, thickness, uniformity, and ionic conductivity of the free-standing film were measured in the following way, and the results are shown in Table 2 below.

### (1) Possibility of the Form of a Free-Standing Film

By confirming whether the polymer solid electrolyte film is separated from the substrate and can be obtained as a film, it was evaluated whether the form of a free-standing film of the polymer solid electrolyte is possible.

### (2) Thickness

As shown in FIG. 3, for a sample punched out of the prepared polymer solid electrolyte to a size of 3×3 cm², the average thickness was calculated by measuring the thickness at a total of 9 designated positions.

### (3) Uniformity

The deviation between the thicknesses was calculated by the total measured values of the thicknesses of a total of 9 designated positions obtained in the item (2) above. It was judged that the smaller the deviation of the calculated thickness is, the more uniform thickness is achieved.

### (4) Ionic Conductivity

The sample of the polymer solid electrolyte obtained in item (3) was brought into contact with a SS electrode having the same surface area as the sample, and then, an alternating voltage was applied through the electrodes on both sides of the sample at room temperature. At this time, as an applied condition, a measurement frequency was set in an amplitude range of 0.01 Hz to 1 MHz, and impedance was measured using VMP3 from BioLogic company. The resistance of the polymer solid electrolyte was obtained from the intersection (Rb) where the semicircle or straight line of the measured impedance trajectory meets the real axis, and the ionic conductivity of the polymer solid electrolyte was calculated from the width and thickness of the sample.

$$σ ( S \cdot {cm}^{- 1} ) = \frac{1}{{R}_{b}} \frac{t}{A} \qquad [ Equation 1 ]$$

σ: Ionic conductivity
Rb: Intersection with the real axis of the impedance trajectory
A: Width of the sample
t: Thickness of the sample

TABLE 2

| | Possibility | | | Ionic |
|---|---|---|---|---|
| | of form of | Average | Uniformity | conductivity |
| | free-standing | thickness | (deviation, | (S/ |
| | film | (μm) | μm) | cm@80° C.) |
| Example 1 | possible | 28.8 | 0.63 | 1.2E−05 |
| Example 2 | possible | 32.3 | 0.67 | 2.6E−05 |
| Example 3 | possible | 24.7 | 0.47 | 4.5E−05 |
| Comparative | impossible | — | — | — |
| Example 1 | | | | |
| Comparative | possible | 21.6 | 1.42 | 1.1E−05 |
| Example 2 | | | | |
| Comparative | impossible | not | not | — |
| Example 3 | (existing as | measurable | measurable | |
| | Liquid, not as | | | |
| | a membrane) | | | |
| Comparative | possible | 20.2 | 1.13 | — |
| Example 4 | (no phase- | | | |
| | separation) | | | |

As shown in Table 2, it was confirmed that the polymer solid electrolytes of Examples 1 to 3, prepared by using PPC as the polymer and PEG-POSS as the non-volatile liquid-phase compound in an appropriate weight ratio, are obtained in the form of a free-standing film. In addition, it can be seen that the polymer solid electrolytes of Examples 1 to 3 are prepared uniformly with a small thickness deviation, and it was confirmed that they had excellent ionic conductivity. In addition, the polymer solid electrolyte of Comparative Example 1 was prepared without using a non-volatile liquid-phase compound, and it was not prepared in the form of a free-standing film, and thus the thickness and ionic conductivity could not be measured.

In addition, the polymer solid electrolyte of Comparative Example 2 was prepared without using a non-volatile liquid-phase compound and prepared using a PET release film instead of a SS Foil as a substrate, and it was confirmed that Comparative Example 2 was manufactured in the form of a free-standing film, but the uniformity was not good because of the large thickness deviation, and the ionic conductivity was also relatively lowered compared to Examples 1 to 3. In general, in the case of PET release film as a substrate, it is relatively easier to separate the electrolyte film after drying due to lower adhesion to the substrate, as compared to an electrolyte film prepared on metal foils such as SS, Cu, or Al. However, if the strength of the electrolyte film is weak, the electrolyte film may be torn or deformed by stretching, which may eventually make it difficult to use.

On the other hand, in the case of Comparative Example 3, PEG-POSS, which is the non-volatile liquid-phase compound, was used excessively compared to PPC, which is the polymer, so that the electrolyte was not prepared in the form of a film, but existed in the state of a liquid. Accordingly, the thickness, uniformity and ionic conductivity could not be measured.

In addition, it was confirmed that in the case of Comparative Example 4, PEG-POSS, which is a non-volatile liquid-phase compound, is used too little compared to PPC, which is a polymer, so that phase-separation of the polymer and the non-volatile liquid-phase compound did not occur, and thus a film was formed in a state in which the polymer and the non-volatile liquid-phase compound were mixed, and the uniformity was not good because of a large thickness deviation.

From these results, it was confirmed that by using a polymer and a non-volatile liquid-phase compound, which are not compatible with each other, in an appropriate weight ratio, and using a phase-separation of the polymer and the non-volatile liquid-phase compound to prepare a polymer solid electrolyte, the polymer solid electrolyte in the form of a free-standing film comprising a liquid-phase film and a polymer solid electrolyte film, formed by phase-separation of the polymer and the non-volatile liquid-phase compound, is obtained, and the polymer solid electrolyte has excellent uniformity and ionic conductivity.

Although the present disclosure has been described above with limited examples and drawings, the present disclosure is not limited thereto, and various modifications and variations are possible, by those of ordinary skill in the art to which the present disclosure belongs, within the scope of equivalents to the technical spirit of the present disclosure and the claims to be described below.

### DESCRIPTION OF REFERENCE NUMERALS

10: Substrate
20: Liquid-phase film
30: Polymer solid electrolyte film

1. A method for preparing a polymer solid electrolyte, the method comprising:
preparing a solution of a polymer, a non-volatile liquid-phase compound, a lithium salt, and a solvent;
forming a coating layer by applying the solution on a substrate;
drying the coating layer to form a liquid-phase film and a polymer solid electrolyte film; and
separating the polymer solid electrolyte film and the liquid-phase film from the substrate.

2. The method according to claim 1, wherein the liquid-phase film comprises the non-volatile liquid-phase compound, and the polymer solid electrolyte film comprises the polymer and the lithium salt,
wherein the non-volatile liquid-phase compound is immiscible with the polymer, and
wherein the liquid-phase film is formed on the substrate and the polymer solid electrolyte film is formed on the liquid-phase film.

3. The method according to claim 1, wherein a weight ratio of the polymer and the non-volatile liquid-phase compound in the solution is 1:0.8 to 1:5.5.

4. The method according to claim 1, wherein the polymer comprises one or more selected from the group consisting of polypropylene carbonate (PPC), polyacrylonitrile (PAN), and polyvinylpyrrolidone (PVP).

5. The method according to claim 1, wherein the non-volatile liquid-phase compound comprises one or more selected from polyhedral oligomeric silsesquioxane (POSS) and ionic liquid.

6. The method according to claim 5, wherein POSS comprises one or more functional groups, wherein the one or more functional groups comprise one or more elements selected from O, N, S, Si and P, or are capable of binding to a lithium ion.

7. The method according to claim 6, wherein the one or more functional groups are selected from the group consisting of poly(ethylene glycol) (PEG), alcohol, amine, carboxylic acid, allyl, epoxide, thiol, silane, and silanol.

8. The method according to claim 5, wherein the ionic liquid comprises a cation and an anion, and the cation comprises one or more selected from the group consisting of imidazolium, pyrazolium, triazolium, thiazolium, oxazolium, pyridazinium, pyrimidinium, pyrazinium, ammonium, phosphonium, pyridinium and pyrrolidinium, each of which are unsubstituted or substituted by an alkyl group having 1 to 15 carbon atoms, and
wherein the anion comprises one or more selected from the group consisting of PF₆⁻, BF₄⁻, CF₃SO₃⁻, N(CF₃SO₂)₂⁻, N(C₂F₅SO₂)₂⁻, C(CF₂SO₂)₃⁻, AsF₆⁻, SbF₆⁻, AlCl₄⁻, NbF₆⁻, HSO₄⁻, ClO₄⁻, CH₃SO₃⁻, and CF₃CO₂⁻.

9. The method according to claim 1, wherein the lithium salt comprises one or more selected from the group consisting of LiTFSI (lithium bis(trifluoromethanesulphonyl)imide), LiFSI (Lithium bis(fluorosulfonyl)imide), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, and (FSO₂)₂NLi.

10. The method according to claim 1, wherein the substrate comprises one or more selected from the group consisting of stainless steel, a copper (Cu) foil, and an aluminum (Al) foil.

11. The method according to claim 1, wherein forming the coating layer is performed by bar coating, roll coating, spin coating, slit coating, die coating, blade coating, comma coating, slot die coating, lip coating, or solution casting.

12. The method according to claim 1, wherein a weight ratio of the polymer and the lithium salt is 1:0.5 to 1:3.

13. The method according to claim 1, wherein the solvent comprises one or more selected from the group consisting of propylene carbonate (PC), ethylene carbonate (EC), butylene carbonate (BC), diethyl carbonate (DEC), dimethyl carbonate (DMC), dipropyl carbonate (DPC), methyl propionate (MP), dimethyl sulfoxide, dimethoxyethane, diethoxyethane, tetrahydrofuran, N-methyl-2-pyrrolidone (NMP), ethylmethyl carbonate (EMC), vinylene carbonate (VC), gamma butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, ethyl propionate, and butyl propionate.

14. The method according to claim 1, wherein drying the coating layer is performed at 150° C. or less.

15. A polymer solid electrolyte comprising the polymer and the lithium salt, prepared by the method according to claim 1.

16. The polymer solid electrolyte according to claim 15, wherein a thickness of the polymer solid electrolyte is 23 μm to 35 μm.

17. The polymer solid electrolyte according to claim 15, wherein a thickness deviation of the polymer solid electrolyte is 0.7 μm or less, and the thickness deviation is calculated from a deviation between a thickness at the thickest position and a thickness at the thinnest position among thicknesses measured at total of 9 designated positions in a sample punched out of the polymer solid electrolyte to a size of 3×3 cm².

18. The polymer solid electrolyte according to claim 15, wherein
the polymer solid electrolyte is in the form of a free-standing film.

19. The polymer solid electrolyte according to claim 15,
wherein an ionic conductivity of the polymer solid electrolyte measured at 80° C. is from 1.2×10⁻⁵ to 4.5×10⁻⁵ S/cm.

20. An all-solid battery comprising the polymer solid electrolyte of claim 15.
